(19) United States
(12) Patent Application Publication
(10) Pub. No.: US 2003/0014305 A1
(43) Pub. Date: Jan. 16, 2003

(54) Method of encouraging re-patronage by offering souvenir adornments at different associated business locations

(76) Inventor: Jeffrey Harden, Kirksville, MO (US)

Correspondence Address: William B. Kircher, SHOOK, HARDY & BACON L.L.P., 1200 Main Street, Kansas City, MO, 64105-2118, US

(21) Appl. No.: 09/903,953

(22) Filed: Jul. 12, 2001

(51) Int. Cl. G06F 17/60

(52) U.S. Cl. 705/14

(57) ABSTRACT

The invention is a method of encouraging re-patronage by consumers by providing a decorative article and then offering decorative adornments at different associated business locations. Each business location offers a unique adornment in exchange for the customers patronage. After the customer patronizes a number of different business locations, he or she is able to create a commemorative item or souvenir. Another feature of the invention is a method of gleaning information from the existing article and adornments when an adornment is received from a subsequent location and then using that information for marketing analysis purposes.

### FIELD OF THE INVENTION

The present invention relates generally to retail business promotions, and more specifically, to promotions designed to encourage repeated patronage by consumers to a particular business at different business locations.

### BACKGROUND OF THE INVENTION

When in unfamiliar surroundings, customers often randomly select a particular hotel or restaurant based on mere convenience alone. In fact, these customers have little or no incentive to pick one particular business over another. Marketers are constantly searching for new promotional ideas to encourage consumers to visit different locations of the same business (i.e., franchised outlets), or, in other words, inspire customer loyalty from location to location.

This customer loyalty is especially important to businesses when the customer is a traveler. The typical traveler has little or no reason to repeatedly return to a particular business (i.e., hotel chains, fast food restaurants) while away from home because he or she is unfamiliar with the surroundings and “one place must be as good as the next.” Therefore, there is a need in the art for a promotional program that would overcome the traveler's lack of incentive to repeatedly visit the same business at different locations or points along that particular traveler's journey.

Innovative programs are also needed to encourage repeat customer business by promoting a particular event, such as a holiday. The offer of holiday souvenirs (i.e., Christmas ornaments) along with a product sold by a business has been used as part of a promotional campaigns in the past. However, the problem with such past programs is that they do not encourage repeat business at different business locations. Oftentimes the customer's patronage of the business in response to the offered souvenir results in only one promotion inspired visit. This is because there is no incentive to return to the business after the customer has already obtained the promotional item. Therefore, there is a need in the art for a holiday-related promotional program which would provide incentive for the customer to return to the business multiple times.

Finally, there is a need in the art for a method of collecting purchaser information regarding customer buying habits; especially, purchasers who travel and/or patronize different locations of the same business. By collecting purchaser information, the business would be able to utilize the information for marketing analysis. Retail companies are typically very interested in data which can be obtained that reflects a particular consumer's purchasing behavior in regard to specific products at selected times of the year and at different geographic locations.

### SUMMARY OF THE INVENTION

Applicant has invented a unique method which satisfies each of the aforementioned desires regarding promotional programs. More specifically, applicant has developed a method of motivating customer return visits by offering souvenir adornments at different business locations. The offered adornments will provide customers incentive to remain loyal to a particular business even when in unfamiliar surroundings or otherwise.

One feature of the present invention is to provide a commemorative item or article capable of receiving adornments which would be obtainable preferably only at different locations of an associated business enterprise. The adornments would be offered at different business locations in exchange for a particular sales item or service. This would allow the customer to accumulate a series of the adornments which when, attached to the article, create a commemorative souvenir uniquely reflecting the individual customer's personal travels. The adornments themselves depict some form or representation that is geographically significant and linked to the place in which it was obtained. By obtaining a number of adornments and attaching them to the article, the consumer is able to create a personalized commemorative souvenir.

Another related object of the present invention is to provide a method of encouraging customer patronage at multiple business locations wherein the indicia on an article and on attached adornments relate to a particular event. However, in this instance the adornments for the event driven promotion are related to various events or subevents which, if collected from different business locations, would allow the consumer to create a commemorative souvenir.

Yet another object of the invention is to create a method of collecting sales and customer behavior information by using the above noted promotional methods. This objective is accomplished by inconspicuously marking the article and adornments with desired purchase information to be monitored by the company (e.g. date and location of purchase). This data would then be monitored at each successive purchase location giving the business a “real-time” progressive picture of the customer's purchasing behavior (last franchise location patronized, times of transactions, frequency of transactions, etc.) and may employ the use of computer networking or the internet to optimize the necessary sharing of information.

Additional objects, advantages and novel features of the invention will be set forth in part in the description which follows, and in part will become apparent to those skilled in the art upon examination of the following or maybe learned from the practice of the invention. The objects and advantages of the invention may be realized and obtained by means of the instrumentalities and combinations particularly pointed out in the appended claims.

### BRIEF DESCRIPTION OF THE DRAWINGS

FIG. 1 is a flowchart illustrating the travel promotion embodiment of Applicant's invention.

### DETAILED DESCRIPTION

As suggested above, this invention has particular utility when utilized in conjunction with food franchises such as a McDonald's®, Burger King®, Dairy Queen®, and the like. That franchise business operation or business would initially select a specific souvenir item. This item (or “article”) could be any kind of collector's or souvenir-type item, for example, a mug, travel bag, or T-shirt. This article would be selected by any kind of retail company (i.e., fast food chains, restaurants, retail shops, convenience stores, gas stations, hotels) and would usually include either printed wording or decorative indicia (i.e., a trademark) linking or identifying the article with the source of origin of the associated goods and services. The article may be obtained by the customer at any of the businesses locations either free of charge, or with the purchase of a particular item or service from that business. This would likely occur in conjunction with a celebrating a particular event or related to vacation traveling or any other such subject. Additionally, the article may initially be inconspicuously marked or coded with desired information to be monitored by the company (i.e., date, location, time of purchase).

The subject invention includes the use of adornments which are capable of being either attached or otherwise placed on the article by marking or other means. These adornments would be different at each location, and could take the form of decals, patches, stamps, pins or any other similar attachable means identifying patronage at a particular location. This enables the customer to obtain a series of differing adornments depending on where and how many of the business' locations he or she has patronized. Because the adornments are different from location to location, the customer must repeatedly visit different locations of the same business (for example, visit McDonald's® restaurants on a driving trip) in order to obtain a variety of adornments. At the end of a preselected time period, vacation, or trip, customers will have created their own unique and personalized souvenir reflecting the various destinations they visited in the course of their travels. As with the article, the adornments may also be inconspicuously labeled with desired information in the form of mere inscription, machine readable bar codes, or any other known method.

Another feature of the invention resides in the fact that both the identifying information on the article and the adornments may be inconspicuously monitored by each business location subsequently visited by a particular consumer. This is done by reading the earlier labeled information from the earlier obtained adornments either manually or using optical scanning or other digital reading devices. By reading the coded information when the article is brought into a particular business location to obtain a new adornment, the business, via documenting the information obtained from the article and/or series of earlier-obtained adornments, may use said information for the purpose of conducting “real-time” marketing analysis. Both the recording of information and analysis thereof may be greatly assisted through the use of conventional computer technologies. For example, each business location could have an optical scanner and computer which it would use to record any desired information from the article and the attached adornments (i.e., (i) the particular item or service that was purchased; (ii) when, where, and by whom the purchase was made, and (iii) demographically significant customer information ). The local computer would then be networked with the other computers (both servers and clients) utilized in the same business.

Another way the businesses (franchises and the like) could share the real time recorded information is over the internet. This may be done by simply posting the recorded information on a common website, thereby enabling both electronic communications with all of the associated businesses locations, but also with the customers themselves. Customers could monitor their travels by reviewing the information provided. Further, the website could be used to enable the customer to redeem a prize or other benefit as the result of his or her collecting adornments from different business locations. It is also contemplated that a computer network or internet website linking would be able to provide all computer enabled locations of the business with real time information with respect to any particular customer participating in the promotion.

An analysis of the locations patronized by the consumer, the times of the transactions, the frequency of the transactions and other such information would allow the business to analyze customer behavior with respect to its products and customer demographics at selected times of the year. This type of consumer information is known to be extremely valuable to businesses in terms of seasonal products to be offered for sale, staffing, inventory control, and energy requirements.

From the foregoing, it is apparent that applicant's method could be used with numerous marketing or promotional schemes. However, two examples of applicant's method put into practice are provided below.

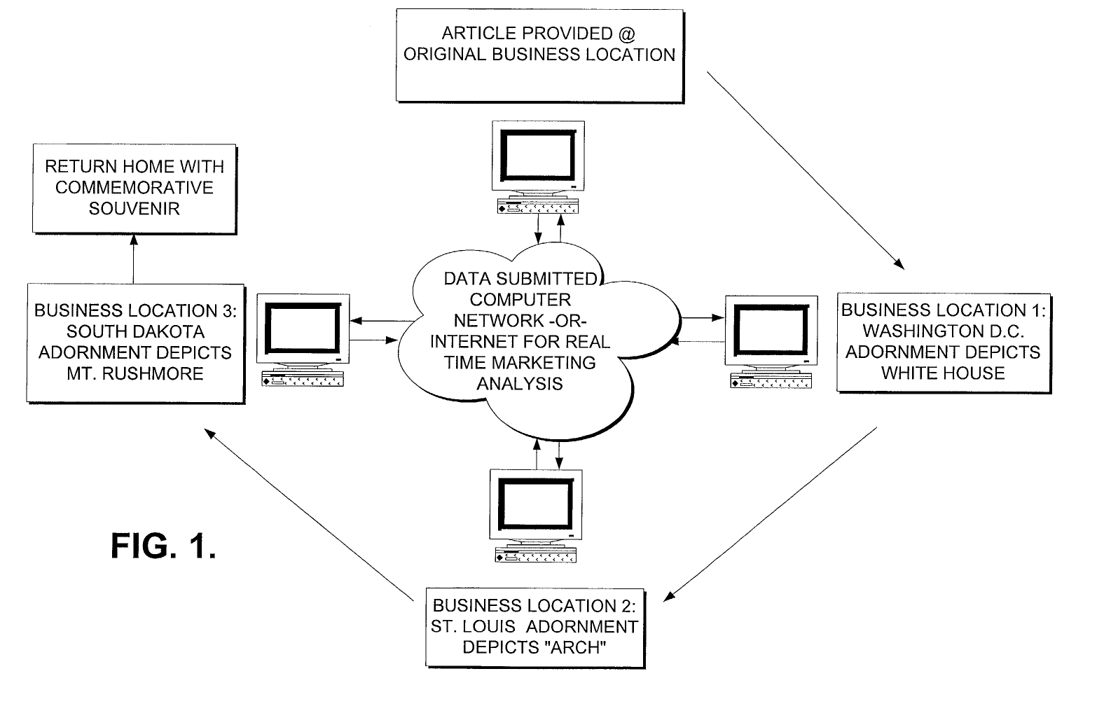

The example illustrated in FIG. 1 is referred to as the travel promotion. The travel promotion involves the use of an article as described above. It is preferred that the selected article is specifically related to travel (i.e., a travel bag, car mug) in order to be in harmony with the promotional theme. It is also preferred that the article contains indicia of the providing business. In addition to containing indicia of the particular business that is dispersing the article as part of its promotion, the article may also contain written words or decorations consistent with the travel theme. For example, a travel bag may contain a vacation slogan (i.e., “my summer vacation”) or a T-shirt might contain a slogan identifying a particular travel occasion. After receiving the article from one business location, the consumer would then take it to another business location to receive an adornment. The adornment at the second location would contain indicia or decorations geographically linking it to the area or location in which it was obtained. For example, the embodiment disclosed in FIG. 1 shows that an adornment obtained in St. Louis might depict an arch, or St. Louis Rams logo whereas an adornment obtained in Washington, D.C. might contain a picture of the White House or the Lincoln Memorial or an adornment obtained in South Dakota might contain a picture of Mount Rushmore. Additionally, the adornments should contain inconspicuous computer readable customer purchasing information (i. e., price, items purchased, time and/or date of purchase) thereon. By toting the article from location to location in the course of a summer vacation, the customer is able to collect a series of adornments that, when attached to the article, creates a commemorative souvenir. This souvenir reflects each of the places visited during the customer's travels while at the same time recording customer purchasing activities. Of course, the customer would have to make successive purchases from numerous associated business locations along the way in order to obtain enough adornments to complete the souvenir. The goal of creating a more complete souvenir would compel the customer to patronize a particular business repeatedly during the course of the trip in order to obtain the needed adornments. Additionally, the business could offer further incentives such as prizes or discounts for different levels of achievement in collecting adornments.

An additional feature of Applicant's travel promotion is a computer aided method of gleaning demographic information from the article and adornments. Because the article and obtained adornments contain purchase information inconspicuously labeled thereon, and then reading and recording this information either manually, with the aid of scanning computer technology, or any other method of reading digitally recorded information, the business could use the information obtained for marketing analysis purposes.

The travel promotion embodiment of Applicant's invention depicted in FIG. 1 shows the use of a computer computer network technologies to aid in obtaining the necessary customer purchasing information. In this embodiment, each business location has a computer which it uses to record desired demographic information from the article and the attached adornments. The local computer would then be networked with the other computers (both server and client) operated within the same business. This provides all computer enabled locations of the business with real time information with respect to a particular customer participating in the promotion. Cross-communication of the local computers can also be accomplished using a site on the internet to reciprocally share information. Either computer networking or the internet linking can accomplish the real time recording and sharing goals.

Another example of applicant's invention would be the “holiday” promotion. The holiday promotion is similar to the travel promotion except that the themes represented on the article and adornments are holiday-related (i.e., Christmas tree mug with attachable ornaments, etc.). As with the travel promotion, the seasonal or holiday promotion would involve the disbursement of an article at any business location. This article may have a holiday-related indicia or decorations thereon as well as indicia that links the article to the business (i.e., a trademark or trade name). The holiday event may be dividable into sub-events (i.e., the 12 days of Christmas). Different adornments should then be distributed to different business locations. Each location should be allocated a particular adornment(s) which it is to distribute upon the purchase of a particular product or service. Each location's adornments should depict a particular sub-event (i. e., each store would only have adornments for one of the 12 days of Christmas). Thereby, by visiting either different business locations, or by visiting the same location on successive or different dates, the customer could accumulate and attach a variety of adornments to the article, such as all twelve days of Christmas, thus creating a holiday souvenir. The holiday or event promotion would have the same data collection advantages to the business as would the travel promotion.

The subject method of using an article and adornments to encourage repeat business by customers to multiple associated locations and increasing frequency thereof could be applied to numerous other types of promotional themes. For example, the method could be employed to promote attendance at a sequence of sporting events. Further, such an adornment program could be used to promote class attendance as part of a college course and many other programs, all of which fall within the scope of this invention. Thus, while the preferred embodiments of applicant's method have been described in order to explain the principles of the method, it is understood that various modifications could be made to the method without departing from its scope as set forth in the appended claims.

I claim:

1. A method of encouraging customer patronage at multiple associated business locations comprising:
providing an adornment receiving article to a patron;
providing distinctive adornments to the patron at different business locations wherein the adornments are attachable to the article.

2. The method of claim 1 including the step of providing purchase information on one of the adornments or the article.

3. The method of claim 2 including the step of reading the purchase information at successive business locations.

4. The method of claim 3 including the step of sharing the purchase information that has been read with other business locations.

5. The method of claim 3 including the step of analyzing customer behaviors using the purchase information read from one of said adornments and said article.

6. The method of claim 1 including the step of encouraging the patron to accumulate a plurality of adornments for an article thereby creating a commemorative article.

7. The method of claim 6 including the step of providing purchase information on one of the adornments or the article.

8. The method of claim 7 including the step of reading the purchase information at successive business locations.

9. The method of claim 8 including the step of sharing the purchase information that has been read with other business locations.

10. The method of claim 8 including the step of analyzing customer behaviors using the purchase information read from one of said adornments and said article.

11. The method of claim 1 including the step of displaying the purchase information on the adornments in an inconspicuous manner.

12. The method of claim 11 in which the purchase information provided on the adornments is one or more of the patron's name, purchase time, purchase location, and item purchased.

13. The method of claim 11 wherein the purchase information on each adornment is provided in machine readable form and the said reading step further includes the step of machine reading the purchase information and electronically recording the purchase information.

14. The method of claim 13 wherein the machine reading is accomplished using an optical scanner.

15. The method of claim 13 including the step of providing a computer network linking the computers at the different business locations so that the purchase information can be more efficiently shared.

16. The method of claim 13 including the step of providing a website on the internet which receives the purchase information from different business locations and then can be simultaneously shared by the different business locations and its customers.

17. The method of claim 11 wherein the reading step includes the step of manually recording the purchasing information from the adornments.

18. The method of claim 1 including the step of providing geographically significant indicia on each adornment.

19. The method of claim 18 including the step of linking the geographically significant indicia with the location at which it was obtained.

20. The method of claim 19 including the step of encouraging the patron to visit multiple business locations to obtain adornments causing the attachment of adornments from different business locations to commemorate that patron's travel.

21. The method of claim 1 including the step of providing indicia on the article and each particular adornment relating to a particular event.

22. The method of claim 21 in which the particular event has sub-events and each adornment displays indicia of a particular sub-event.

23. A method of encouraging customer patronage at multiple associated business locations comprising:
providing an adornment receiving article to the patron;
providing distinctively commemorative adornments to patrons at different business locations contingent on the purchase of a particular product or service the adornments capable of being attached to the article;
providing information on an adornment;
reading the adornment information at successive business locations patronized; and
analyzing patron behaviors using the adornment information.
